(19) United States
(12) Patent Application Publication
(10) Pub. No.: US 2025/0117710 A1
(43) Pub. Date: Apr. 10, 2025

(54) METHOD OF DEPLOYING MULTIMODAL LARGE MODEL, ELECTRONIC DEVICE AND STORAGE MEDIUM

(71) Applicant: Beijing Baidu Netcom Science Technology Co., Ltd., Beijing (CN)

(72) Inventors: Mingxiu ZHANG, Beijing (CN); Yahui WANG, Beijing (CN); Fangxin SHANG, Beijing (CN); Jun CHEN, Beijing (CN); Haifeng HUANG, Beijing (CN)

(21) Appl. No.: 18/985,365

(22) Filed: Dec. 18, 2024

(30) Foreign Application Priority Data
Sep. 12, 2024 (CN) 202411282844.X

(51) Int. Cl. G06N 20/00; G10L 25/27

(52) U.S. Cl. CPC G06N 20/00; G10L 25/27

(57) ABSTRACT

Provided is a method of deploying a multimodal large model, an electronic device and a storage medium, relating to field of artificial intelligence technology, and in particular, to fields of deep learning and model deployment. The method includes: splitting a first multimodal large model into a visual part and a linguistic part; determining a first static graph model corresponding to the visual part and a second static graph model corresponding to the linguistic part; and deploying the first multimodal large model based on the first static graph model and the second static graph model.

### CROSS-REFERENCE TO RELATED APPLICATIONS

The present application claims priority to Chinese Patent Application No. CN202411282844.X, filed with the China National Intellectual Property Administration on Sep. 12, 2024, the disclosure of which is hereby incorporated herein by reference in its entirety.

### TECHNICAL FIELD

The present disclosure relates to a field of artificial intelligence technology, and in particular, to fields of deep learning and model deployment.

### BACKGROUND

Multimodal large models have demonstrated outstanding performance in fields such as natural language processing, computer vision, and speech recognition. These models provide more comprehensive and accurate understanding and generation capabilities by integrating a plurality of data modalities such as text, image, and audio. However, due to their large number of parameters and complex computational requirements, they face many challenges in practical deployment.

### SUMMARY

The present disclosure provides a method and apparatus of deploying a multimodal large model, an electronic device and a storage medium.

According to an aspect of the present disclosure, a method of deploying a multimodal large model is provided, which includes:
splitting a first multimodal large model into a visual part and a linguistic part;
determining a first static graph model corresponding to the visual part and a second static graph model corresponding to the linguistic part; and
deploying the first multimodal large model based on the first static graph model and the second static graph model.

According to another aspect of the present disclosure, an apparatus of deploying a multimodal large model is provided, which includes:
a model split module configured to split a first multimodal large model into a visual part and a linguistic part;
a static graph deriving module configured to determine a first static graph model corresponding to the visual part and a second static graph model corresponding to the linguistic part; and
a deploying module configured to deploy the first multimodal large model based on the first static graph model and the second static graph model.

According to another aspect of the present disclosure, an electronic device is provided, which includes:
at least one processor; and
a memory connected in communication with the at least one processor;
where the memory stores an instruction executable by the at least one processor, and the instruction, when executed by the at least one processor, enables the at least one processor to execute the method of any one of the embodiments of the present disclosure.

According to another aspect of the present disclosure, a non-transitory computer-readable storage medium storing a computer instruction thereon is provided, where the computer instruction is used to cause a computer to execute the method of any one of the embodiments of the present disclosure.

According to another aspect of the present disclosure, a computer program product is provided, which includes a computer program, where the computer program, when executed by a processor, implements the method of any one of the embodiments of the present disclosure.

According to embodiments of the present disclosure, it is possible to optimize hardware resource utilization of deploying the multimodal large model and improve utilization rate of hardware resources, thereby improving inference speed.

It should be understood that contents described in this part is not intended to identify critical or important features of the embodiments of the present disclosure, nor is it intended to limit the scope of the present disclosure. The other features of the present disclosure are made easy to understand by the following description.

### BRIEF DESCRIPTION OF THE DRAWINGS

Accompanying drawings are provided for a better understanding of the present scheme and do not constitute a limitation of the present disclosure, in which:

FIG. 1 is a flow schematic diagram of a method of deploying a multimodal large model according to an embodiment of the present disclosure;

FIG. 2 is a schematic diagram of an application example of a method of deploying a multimodal large model according to an embodiment of the present disclosure;

FIG. 3 is a schematic diagram of another application example of a method of deploying a multimodal large model according to an embodiment of the present disclosure;

FIG. 4 is a schematic block diagram of an apparatus of deploying a multimodal large model according to an embodiment of the present disclosure;

FIG. 5 is a schematic block diagram of an apparatus of deploying a multimodal large model according to another embodiment of the present disclosure; and

FIG. 6 is a block diagram of an electronic device for achieving a method of deploying a multimodal large model according to an embodiment of the present disclosure.

### DETAILED DESCRIPTION

Hereinafter, explanation of exemplary embodiments of the present disclosure will be made in conjunction with the accompanying drawings, which includes various details of the embodiments of the present disclosure to facilitate understanding and should be considered merely exemplary. Therefore, those having ordinary skill in the art should recognize that various changes and modifications may be made to the embodiments described herein without departing from the scope of the present disclosure. Similarly, for clarity and conciseness, descriptions of well-known functions and structures are omitted in the following descriptions.

In order to facilitate understanding of a method of deploying a multimodal large model provided in the embodiments of the present disclosure, related technologies of the embodiments of the present disclosure are described below. The following related technologies may be arbitrarily combined with technical solutions of the embodiments of the present disclosure as optional solutions, which all fall within the protection scope of the embodiments of the present disclosure.

At present, a default inference manner for most multimodal large models is based on 16 bits floating-point type (Float Point 16, FP16). Although FP16 provides higher accuracy, it may cause a model to consume a large amount of video memory during inference and increase inference time consumption, making the model unusable in a resource limited environment. To solve this problem, the model will be quantized in related technologies, with the most commonly used manner being 8 bits integer type (INT8) quantization. There are two implementation methods for the INT8 quantization, one is to only quantify weights (called WINT8), and the other is to quantify both activations and weights (called W8A8). In theory, using the INT8 quantization may not only reduce the video memory occupied by the model during inference, but also accelerate an inference process. However, in practice, a manner of using the INT8 quantization requires the model to undergo an inverse quantization process during an inference stage, resulting in an increase in computation time after quantization. Therefore, there is a need for a solution that can reduce video memory usage during inference and accelerate a model process. The following introduces some mainstream model inference frameworks.

### (1) LLM.int8

LLM.int8 is an adaptive mixed accuracy quantization method that uses different accuracies to represent different types of data, in order to improve computational efficiency and accuracy. In a LLM.int8 solution, each element in an input feature is first classified based on its numerical size and importance. An element identified as an outlier is specifically marked, while the remaining elements are treated as regular values. For the regular values, 8 bits quantization is used for processing, which may significantly reduce storage and computational requirements. For the outlier, its original 16 bits accuracy is retained to ensure that these important features will not lose too much information during a calculation process due to quantization. Through this mixed accuracy decomposition method, the method successfully reduces the video memory usage during the inference process while maintaining predictive performance of the model.

### (2) AirLLM

The core technology of AirLLM lies in its efficient memory management mechanism, which adopts an advanced caching strategy and a data flow scheduling algorithm to achieve effective reuse of model weights and intermediate results, thereby significantly reducing a requirement for a video memory space. Technological highlights behind AirLLM also include intelligent splitting and reordering of computational graphs, which further reduces unnecessary memory usage. Through hierarchical inference, AirLLM may only load necessary layer data from a disk when executing a specific layer, and release a memory after completing calculations, so that only necessary sub-models remain in the memory at any given time. In addition, AirLLM also applies a block quantization technology to further compress the sub-models, thereby reducing disk loading time and memory usage amount.

### (3) VLLM

VLLM is an open-source framework for large model inference and acceleration, and is designed to provide efficient memory management and computational optimization for large language models during the inference stage. The core technology of VLLM lies in the PagedAttention algorithm it adopts. The algorithm effectively manages a key tensor and a value tensor in an attention mechanism, solving a problem of low video memory utilization in traditional autoregressive models. The PagedAttention divides a Key-Value (KV) cache into fixed sized blocks and stores these blocks in discontinuous memory spaces, thereby avoiding problems of video memory fragmentation and excessive reservation, and making the video memory utilization close to a theoretical optimal value.

Usage of the LLM.int8 solution may reduce the video memory usage of the model during inference, but inference speed is significantly reduced. This is because the inference stage requires the inverse quantization process, resulting in the increase in the computation time after quantization. In addition, AirLLM does not support a multimodal model, while VLLM does not support quantization of the multimodal model. The following will provide a detailed introduction to drawbacks of different solutions.

Due to a special handling of the outlier and usage of mixed accuracy calculations in LLM.int8, computational complexity during the inference process may be increased. Especially on certain hardware accelerators, a difficulty in efficiently decomposing the outlier and performing mixed accuracy operations may result in a decrease in the inference speed compared to using FP16.

Due to frequent loading and unloading of layer data of the model from the disk during the inference process by AirLLM, latency of an I/O (input/output) operation may be increased, especially when read speed of the disk is slow. Therefore, in real-time scenarios or applications that require high inference speed, performance of AirLLM may be affected to some extent. In addition, the performance and effectiveness of AirLLM are also affected by external factors such as disk read and write speeds, network latency, etc. In practical applications, these factors may lead to additional performance fluctuations and uncertainties.

At present, VLLM mainly supports some mainstream large-scale language models. For newly emerging or non-mainstream models, some customization work may be required to adapt. This means that a user may need to consider a range of models it supports when choosing VLLM. Due to adoption of a series of innovative technological means to optimize inference performance in VLLM, its internal implementation is relatively complex. This may pose a certain technical barrier for the user when using and customizing VLLM.

The technical solutions of the embodiments of the present disclosure may solve at least one of the above technical problems.

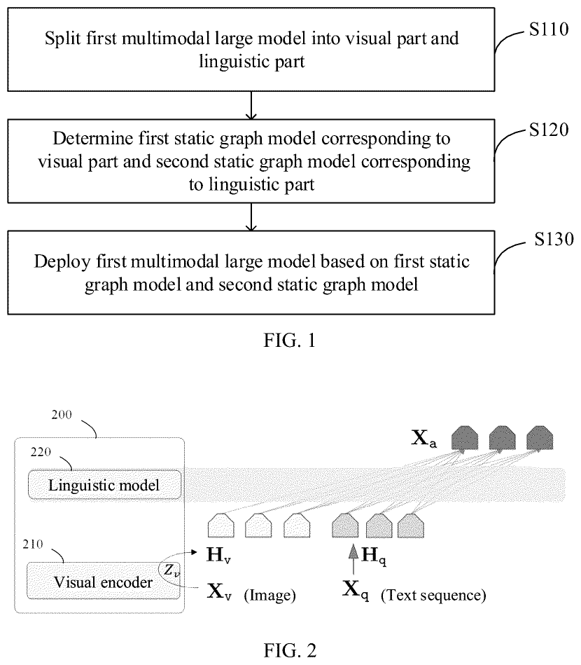

FIG. 1 is a flow schematic diagram of a method of deploying a multimodal large model according to an embodiment of the present disclosure. The method may be applied to an apparatus of deploying the multimodal large model, which may be deployed in an electronic device, such as a single or multi machine terminal, a server, or other processing devices. Where the terminal may be a User Equipment (UE) such as a mobile device, a Personal Digital Assistant (PDA), a handheld device, a computing device, an on-vehicle device, a wearable device, or the like. In some possible implementations, the method may also be achieved by calling a computer-readable instruction stored in a memory by a processor. As shown in FIG. 1, the method may include following steps.

In S110, a first multimodal large model is split into a visual part and a linguistic part.

In S120, a first static graph model corresponding to the visual part and a second static graph model corresponding to the linguistic part are determined.

In S130, the first multimodal large model is deployed based on the first static graph model and the second static graph model.

In the above method, the first multimodal large model may be a large model capable of processing input information having a plurality of modalities. The plurality of modalities include, such as, an image, a text and the like. The large model refers to a machine learning model with extremely large scale of parameters (usually over one billion) and super powerful computing resources, capable of processing massive amounts of data and completing various complex tasks.

For example, the first multimodal large model may be used to process a first image and/or a first text, and output a second image and/or a second text.

In the embodiments of the present disclosure, the first multimodal large model is a model that needs to be deployed on a hardware device. Here, deployment refers to configuring a trained model on the hardware device, which may be referred to as target hardware. Alternatively, a deployment process may include one or more processes such as model structure optimization, model compression, inference and optimization, and hardware adaptation. In practical applications, the deployment of the model may be achieved by generating a prediction program for being run on the target hardware and installing it on the target hardware.

In the embodiments of the present disclosure, the deployment of the first multimodal large model is achieved by determining the static graph models. Where the static graph model is a computational graph model that is defined first and then executed. For the static graph model, a structure of an entire computation graph may be defined first, including layers, nodes, and connection manners of a network, and then data may be passed into the graph for computation. The deployment based on the static graph models allows for static allocation of resources and optimization of computing processes, resulting in high efficiency and performance during execution.

In related technologies, it is not supported to derive a complete multimodal large model as the static graph model, which to some extent limits the deployment and inference efficiency of the multimodal large model in practical applications. In the embodiments of the present disclosure, the first multimodal large model is split into a visual model and a linguistic model. Subsequently, corresponding static graph models are determined for the visual model and the linguistic model, namely the first static graph model and the second static graph model. According to the above method in the embodiments of the present disclosure, utilization of hardware resources in the deployment of the multimodal large model has been optimized, and utilization rate of the hardware resources has been improved. This not only improves inference speed of the multimodal large model, but also reduces hardware resource consumption during actual deployment of the multimodal large model, successfully solving a problem in related technologies that does not support directly deriving the multimodal large model as static graphs. Meanwhile, the split visual and linguistic parts are more flexible and may be easily integrated into various application scenarios, providing new possibilities for practical applications of multimodal tasks.

FIG. 2 is a schematic diagram of an application example of a method of deploying a multimodal large model according to an embodiment of the present disclosure. As shown in FIG. 2, the first multimodal large model 200 includes a visual encoder 210 and a linguistic model 220. Input information of the first multimodal large model 200 may include an image Xᵥ and a text sequence X_{q}. The visual encoder 210 in the first multimodal large model 200 performs an encoding process Zᵥ on the image Xᵥ and the text sequence X_{q}, to obtain processing results Hᵥ and H_{g}, respectively. In the embodiments of the present disclosure, processing results of the encoding process Zᵥ are concatenated and regarded as data in a text sequence form, which is input into the linguistic model 220, and then processed by the linguistic model 220 to obtain output information Xₐ. As such, the first multimodal large model 200 may be split into the visual part (including the visual encoder 210) and the linguistic part (including the linguistic model 220), and derived as static graph models respectively.

Alternatively, the first static graph model corresponding to the visual part and the second static graph model corresponding to the linguistic part may be determined by using a corresponding static graph deriving tool based on a training framework or a version of the first multimodal large model. For example, in a case where the first multimodal large model is a model based on a Paddle framework, a static graph deriving function provided by the Paddle framework may be utilized to derive the two parts as the corresponding static graph models.

In some embodiments, the method of deploying the multimodal large model also includes: obtaining a second multimodal large model to be deployed; in a case where a training framework of the second multimodal large model is different from a target framework, processing weight information in the second multimodal large model based on a weight conversion rule between the training framework of the second multimodal large model and the target framework, to obtain the first multimodal large model. Alternatively, the above step may be performed before splitting the first multimodal large model into the visual part and the linguistic part.

Alternatively, the second multimodal large model may be a large model capable of processing input information of a plurality of modalities. The plurality of modalities include, such as an image, a text and the like. For example, the second multimodal large model may be used to process a third image and/or a third text, and output a fourth image and/or a fourth text.

In the embodiments of the present disclosure, when the training framework of the second multimodal large model to be deployed is different from the target framework, the weight information in the second multimodal large model may be converted, to make the second multimodal large model be converted to the first multimodal large model corresponding to the target framework. Alternatively, when the training framework of the second multimodal large model is the same as the target framework, the second multimodal large model may be used as the first multimodal large model for being deployed.

For example, the target framework is a framework that provides the static graph deriving tool. For example, if the target framework is a Paddle framework and the second multimodal large model to be deployed is obtained by being trained based on a PyTorch framework, weight conversion tools of the PyTorch framework and the Paddle framework are used to convert model weights of the PyTorch version in the second multimodal large model to model weights of the Paddle version based on rules defined in the tools, to obtain the first multimodal large model, split the first multimodal large model into the visual part and the linguistic part, and derive the corresponding static graphs models by using the static image deriving function of the Paddle framework. It may be understood that the second multimodal large model may also be trained based on another deep learning framework such as TensorFlow, Caffe or the like.

According to the above embodiments, it is possible to support deployment of multimodal large models with different training frameworks, thereby improving inference speed of the multimodal large models with different training frameworks and reducing resource consumption of the multimodal large models during actual deployment.

In some embodiments, the above step of determining the first static graph model corresponding to the visual part and the second static graph model corresponding to the linguistic part in S120 includes compiling and installing a custom operator for hardware adaptation of the model; determining the first static graph model based on the custom operator and the visual part; and determining the second static graph model based on the custom operator and the linguistic part.

Alternatively, the custom operator may be an operator created based on an interface provided by the target framework, such as a PaddleNLP custom operator.

According to the above embodiments, the first multimodal large model provides high-level information such as model structure and parameters, the custom operator is compiled and installed in advance to perform low-level hardware adaptation, in order to implement environment preparation for deriving of the static graphs, thereby ensuring effectiveness of static resource allocation and optimization of computing processes, improving deployment efficiency and inference performance.

In some embodiments, the custom operator is further used to convert parameters in the visual part and/or the linguistic part based on graphics card accuracy of the target hardware.

For example, if the target hardware includes a graphics card that does not support BF16 precision, the compiled and installed custom operator may convert parameters of the BF16 precision (including weights and/or activations) in the visual part and/or the linguistic part of the first multimodal large model to the FP16 precision.

According to the above embodiments, the custom operator determines different types of graphics cards, making the operator applicable to more types of graphics cards, improving compatibility with different hardware, and thus enhancing flexibility of model deployment.

In some embodiments, the custom operator includes a save function related operator, and the save function related operator is configured to add different identification information to intermediate output results of different task flows.

For example, the save function related operator may include a save_output operator.

Alternatively, based on the save function related operator, when static graph inference is performed, the intermediate output results of different task flows will be associated with different identification information. When an intermediate calculation result is saved to a disk, the intermediate calculation result will overwrite an original intermediate calculation result with the same identification information in the disk, but will not overwrite an intermediate calculation result with different identification information.

In practical applications, during the static graph inference, the model needs to save the intermediate calculation result on the disk, which may lead to a case where the intermediate result of the model is overwritten in a high concurrency scenario, resulting in an incorrect final output result of the model. According to the embodiments of the present disclosure, the identification information is added to distinguish results of different task flows, effectively avoiding a problem of an intermediate result being overwritten in the model and ensuring that the model may still output an accurate and stable result in the high concurrency scenario.

In some embodiments, deploying the first multimodal large model based on the first static graph model and the second static graph model includes: quantifying the second static graph model to obtain a third static graph model; and obtaining a prediction program based on the first static graph model and the third static graph model, where the prediction program is configured to deploy the first multimodal large model on the target hardware for inference.

For example, after the static graph models are derived and before the prediction program (prediction code) is generated, the linguistic part may be quantified. Alternatively, the prediction program may be generated based on a model development kit provided by the target framework, for example, may be generated by using a multimodal large model development kit PaddleMIX provided by the Paddle framework.

According to the above embodiments, a quantization strategy may be implemented for the linguistic part of the first multimodal large model, which may further optimize performance of the model during inference, reduce video memory usage, and improve inference speed.

In some embodiments, quantifying the second static graph model to obtain the third static graph model includes quantifying weight information of the second static graph model to obtain the third static graph model.

For example, a manner of quantifying the second static graph model may be WINT8 quantization (which only quantifies weights). Compared to a W8A8 quantization manner, WINT8 quantization has significant advantages in maintaining model performance. Although the W8A8 quantization can achieve lower video memory usage, in some cases it may sacrifice certain model accuracy, thereby affecting quality of an inference result. The WINT8 quantization can achieve dual optimization of the video memory usage and the inference speed while maintaining high model accuracy.

Therefore, according to the above embodiments, dual optimization of the video memory usage and the inference speed may be achieved.

In some embodiments, the method of deploying the multimodal large model further includes: creating a KV (key-value) cache based on the prediction program when loading the first multimodal large model for the first time, where the KV cache is configured to store pre-calculated KV information for being called by the first multimodal large model during inference and calculation.

Specifically, by configuring a relevant code in the prediction program, it is possible to create the KV cache when the first multimodal large model is first loaded on the target hardware after configuring the prediction program on the target hardware.

In related technologies, there are some convenient prediction program development tools based on static graph inference, which provide strong support for developers to deploy and test the multimodal large model in practical applications. However, the provided prediction program has a potential performance bottleneck, that is, the program generates a temporary KV cache tensor every time a calculation is performed. This approach increases the video memory usage during inference, which is clearly an issue that cannot be ignored for resource constrained or latency sensitive application scenarios. To address this issue, the embodiments of the present disclosure have conducted in-depth optimization of a prediction code. Specifically, by setting the required KV cache to be created during the first loading of the model, only the first created KV cache needs to be passed in for subsequent calculations, avoiding a need of regenerating a new KV cache every time a calculation is made, thereby reducing the video memory usage during model inference.

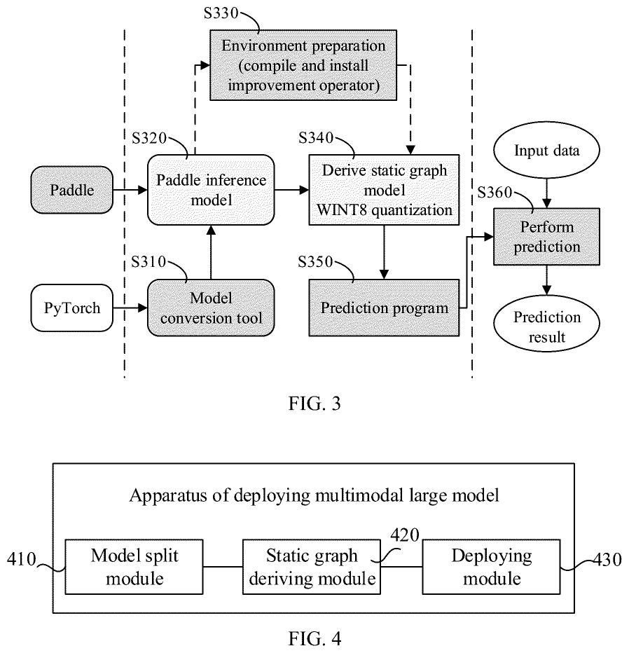

FIG. 3 is a schematic diagram of another application example of a method of deploying a multimodal large model according to an embodiment of the present disclosure. In this application example, high-performance multimodal model deployment based on the Paddle framework may optimize user experience and meet needs of a specific application scenario. Specifically, the method includes following steps.

In S310, a model conversion tool is provided for a model trained by using the PyTorch, to convert the model weights of the PyTorch version to the model weights of the Paddle version.

In S320, a Paddle inference model is determined (obtained based on the conversion in step S310 or directly obtained through the Paddle).

In S330, an improvement operator is compiled and installed to achieve environment preparation.

In S340, a dynamic graph model is converted to the static graph models. A reason why a static graph inference manner of the Paddle framework can improve the inference speed is that it optimizes and compiles a computational graph before model inference, thereby reducing computational overhead during an inference process. This converting step is a core of achieving high-performance model deployment. In order to further improve inference efficiency and performance of the model, this application example also performs the WINT8 quantization on the static graph models.

In S350, the prediction program is generated, in which calculation logic during inference of the Paddle is optimized, which further reduces the video memory usage of the model.

In S360, the model is deployed on the target hardware and predictive inference is performed based on input data to obtain a prediction result.

The static graph inference manner provided by the Paddle framework has significant advantages over a dynamic inference manner of the PyTorch, especially in terms of the inference speed. This feature is particularly important for reducing user waiting time and improving system response efficiency, especially in scenarios such as health Q&A that require immediate feedback. Therefore, the above application example may be applied to model deployment in such scenarios, which may significantly improve user experience.

It can be seen that the embodiments of the present disclosure are suitable for multimodal model quantization deployment in high-performance scenarios and have significant advantages in multiple aspects. Firstly, in terms of the inference speed, the embodiments of the present disclosure can significantly reduce time required for inference. This feature makes them particularly outstanding in low latency scenarios, such as in real-time applications like health Q&A, providing users with a smoother and more immediate experience. Secondly, the embodiments of the present disclosure can significantly reduce the video memory usage of the model. In a multimodal model inference process, the video memory usage is a key limiting factor. By optimizing video memory management, the embodiments of the present disclosure enable more computing resources to be used for actual inference tasks, rather than being limited by the video memory usage, thereby improving inference efficiency. Finally, the embodiments of the present disclosure have broad applicability and can support more types of multimodal models, while most existing technical solutions support inference acceleration for the linguistic model part, which makes the embodiments of the present disclosure more flexible and versatile in the field of multimodal model deployment.

According to the embodiments of the present disclosure, the present disclosure further provides an apparatus of deploying a multimodal large model. FIG. 4 a schematic block diagram of the apparatus of deploying the multimodal large model according to an embodiment of the present disclosure. As shown in FIG. 4, the apparatus includes:
a model split module 410 configured to split a first multimodal large model into a visual part and a linguistic part;
a static graph deriving module 420 configured to determine a first static graph model corresponding to the visual part and a second static graph model corresponding to the linguistic part; and
a deploying module 430 configured to deploy the first multimodal large model based on the first static graph model and the second static graph model.

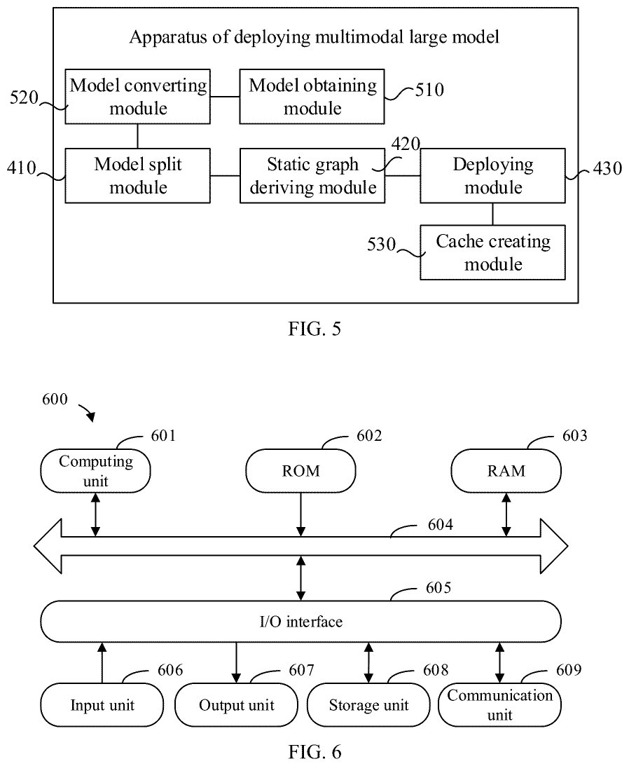

In some embodiments, as shown in FIG. 5, the apparatus further includes:
a model obtaining module 510 configured to obtain a second multimodal large model to be deployed; and
a model converting module 520 configured to, in a case where a training framework of the second multimodal large model is different from a target framework, process weight information in the second multimodal large model based on a weight conversion rule between the training framework of the second multimodal large model and the target framework, to obtain the first multimodal large model.

In some embodiments, the static graph deriving module 420 is configured to:
compile and install a custom operator for hardware adaptation of models;
determine the first static graph model based on the custom operator and the visual part; and
determine the second static graph model based on the custom operator and the linguistic part.

In some embodiments, the custom operator is further configured to convert parameters in the visual part and/or the linguistic part based on graphics card accuracy of target hardware.

In some embodiments, the custom operator includes a save function related operator, and the save function related operator is configured to add different identification information to intermediate output results of different task flows.

In some embodiments, the deploying module 430 is configured to:
quantify the second static graph model to obtain a third static graph model; and
obtain a prediction program based on the first static graph model and the third static graph model, where the prediction program is configured to deploy the first multimodal large model on the target hardware for inference.

In some embodiments, the deploying module 430 is configured to:
quantify weight information of the second static graph model to obtain the third static graph model.

In some embodiments, as shown in FIG. 5, the apparatus further includes:
a cache creating module 530 configured to create a Key-Value (KV) cache based on the prediction program when loading the first multimodal large model for the first time, where the KV cache is configured to store pre-calculated KV information for being called by the first multimodal large model during inference and calculation.

The descriptions to the specific functions and examples of each module and submodule of the apparatus according to the embodiments of the present disclosure may refer to the relevant descriptions of the corresponding steps in the above method embodiments, which will not be repeated herein.

In the technical solution of the present disclosure, acquisition, storage and application of the user's personal information involved are all in compliance with provisions of relevant laws and regulations, and do not violate public order and good customs.

According to the embodiment of the present disclosure, the present disclosure further provides an electronic device, a readable storage medium and a computer program product.

FIG. 6 shows a schematic block diagram of an exemplary electronic device 600 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 6, the device 600 includes a computing unit 601 that may perform various appropriate actions and processes according to a computer program stored in a Read-Only Memory (ROM) 602 or a computer program loaded from a storage unit 608 into a Random Access Memory (RAM) 603. Various programs and data required for an operation of device 600 may also be stored in the RAM 603. The computing unit 601, the ROM 602 and the RAM 603 are connected to each other via a bus 604. The input/output (I/O) interface 605 is also connected to the bus 604.

A plurality of components in the device 600 are connected to the I/O interface 605, and include an input unit 606 such as a keyboard, a mouse, or the like; an output unit 607 such as various types of displays, speakers, or the like; the storage unit 608 such as a magnetic disk, an optical disk, or the like; and a communication unit 609 such as a network card, a modem, a wireless communication transceiver, or the like. The communication unit 609 allows the device 600 to exchange information/data with other devices via a computer network such as the Internet and/or various telecommunication networks.

The computing unit 601 may be various general-purpose and/or special-purpose processing components with processing and computing capabilities. Some examples of the computing unit 601 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 601 performs various methods and processing described above, such as the method of deploying the multimodal large model. For example, in some implementation, the method of deploying the multimodal large model may be implemented as a computer software program tangibly contained in a computer-readable medium, such as the storage unit 608. In some implementations, a part or all of the computer program may be loaded and/or installed on the device 600 via the ROM 602 and/or the communication unit 609. When the computer program is loaded into RAM 603 and executed by the computing unit 601, one or more steps of the method of deploying the multimodal large model described above may be performed. Alternatively, in other implementations, the computing unit 601 may be configured to perform the method of deploying the multimodal large model by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of apparatuses may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware component, or in a computing system including a front-end component (e.g., a user computer with a graphical user interface or a web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and the server are generally far away from each other and usually interact with each other via a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure may be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A method of deploying a multimodal large model, comprising:
splitting a first multimodal large model into a visual part and a linguistic part;
determining a first static graph model corresponding to the visual part and a second static graph model corresponding to the linguistic part; and
deploying the first multimodal large model based on the first static graph model and the second static graph model.

2. The method of claim 1, further comprising:
obtaining a second multimodal large model to be deployed; and
in a case where a training framework of the second multimodal large model is different from a target framework, processing weight information in the second multimodal large model based on a weight conversion rule between the training framework of the second multimodal large model and the target framework, to obtain the first multimodal large model.

3. The method of claim 1, wherein determining the first static graph model corresponding to the visual part and the second static graph model corresponding to the linguistic part comprises:
compiling and installing a custom operator for hardware adaptation of models;
determining the first static graph model based on the custom operator and the visual part; and
determining the second static graph model based on the custom operator and the linguistic part.

4. The method of claim 3, wherein the custom operator is further configured to convert parameters in the visual part and/or the linguistic part based on graphics card accuracy of target hardware.

5. The method of claim 3, wherein the custom operator comprises a save function related operator, and the save function related operator is configured to add different identification information to intermediate output results of different task flows.

6. The method of claim 1, wherein deploying the first multimodal large model based on the first static graph model and the second static graph model comprises:
quantifying the second static graph model to obtain a third static graph model; and
obtaining a prediction program based on the first static graph model and the third static graph model, wherein the prediction program is configured to deploy the first multimodal large model on target hardware for inference.

7. The method of claim 6, wherein quantifying the second static graph model to obtain the third static graph model comprises:
quantifying weight information of the second static graph model to obtain the third static graph model.

8. The method of claim 6, further comprising:
creating a Key-Value (KV) cache based on the prediction program when loading the first multimodal large model for the first time, wherein the KV cache is configured to store pre-calculated KV information for being called by the first multimodal large model during inference and calculation.

9. An electronic device, comprising:
at least one processor; and
a memory connected in communication with the at least one processor;
wherein the memory stores an instruction executable by the at least one processor, and the instruction, when executed by the at least one processor, enables the at least one processor to execute:
splitting a first multimodal large model into a visual part and a linguistic part;
determining a first static graph model corresponding to the visual part and a second static graph model corresponding to the linguistic part; and
deploying the first multimodal large model based on the first static graph model and the second static graph model.

10. The electronic device of claim 9, wherein the instruction, when executed by the at least one processor, enables the at least one processor to further execute:
obtaining a second multimodal large model to be deployed; and
in a case where a training framework of the second multimodal large model is different from a target framework, processing weight information in the second multimodal large model based on a weight conversion rule between the training framework of the second multimodal large model and the target framework, to obtain the first multimodal large model.

11. The electronic device of claim 9, wherein the instruction, when executed by the at least one processor, enables the at least one processor to execute determining the first static graph model and the second static graph model by:
compiling and installing a custom operator for hardware adaptation of models;
determining the first static graph model based on the custom operator and the visual part; and
determining the second static graph model based on the custom operator and the linguistic part.

12. The electronic device of claim 11, wherein the custom operator is further configured to convert parameters in the visual part and/or the linguistic part based on graphics card accuracy of target hardware.

13. The electronic device of claim 11, wherein the custom operator comprises a save function related operator, and the save function related operator is configured to add different identification information to intermediate output results of different task flows.

14. The electronic device of claim 9, wherein the instruction, when executed by the at least one processor, enables the at least one processor to execute deploying the first multimodal large model by:
quantifying the second static graph model to obtain a third static graph model; and
obtaining a prediction program based on the first static graph model and the third static graph model, wherein the prediction program is configured to deploy the first multimodal large model on target hardware for inference.

15. A non-transitory computer-readable storage medium storing a computer instruction thereon, wherein the computer instruction is used to cause a computer to execute:
splitting a first multimodal large model into a visual part and a linguistic part;
determining a first static graph model corresponding to the visual part and a second static graph model corresponding to the linguistic part; and
deploying the first multimodal large model based on the first static graph model and the second static graph model.

16. The non-transitory computer-readable storage medium of claim 15, wherein the computer instruction is used to cause the computer to further execute:
obtaining a second multimodal large model to be deployed; and
in a case where a training framework of the second multimodal large model is different from a target framework, processing weight information in the second multimodal large model based on a weight conversion rule between the training framework of the second multimodal large model and the target framework, to obtain the first multimodal large model.

17. The non-transitory computer-readable storage medium of claim 15, wherein the computer instruction is used to cause the computer to execute determining the first static graph model and the second static graph model by:
compiling and installing a custom operator for hardware adaptation of models;
determining the first static graph model based on the custom operator and the visual part; and
determining the second static graph model based on the custom operator and the linguistic part.

18. The non-transitory computer-readable storage medium of claim 17, wherein the custom operator is further configured to convert parameters in the visual part and/or the linguistic part based on graphics card accuracy of target hardware.

19. The non-transitory computer-readable storage medium of claim 17, wherein the custom operator comprises a save function related operator, and the save function related operator is configured to add different identification information to intermediate output results of different task flows.

20. The non-transitory computer-readable storage medium of claim 15, wherein the computer instruction is used to cause the computer to execute deploying the first multimodal large model by:
quantifying the second static graph model to obtain a third static graph model; and
obtaining a prediction program based on the first static graph model and the third static graph model, wherein the prediction program is configured to deploy the first multimodal large model on target hardware for inference.
